(19) United States
(12) Patent Application Publication
(10) Pub. No.: US 2002/0187460 A1
(43) Pub. Date: Dec. 12, 2002

(54) Method and device for reproducing a recorded flight mission of an aircraft from an observer position by means of a system for flight simulation

(75) Inventors: Jan Luttmann, Berglern (DE); Erwin Burlafinger, Schrobenhausen (DE)

Correspondence Address: CROWELL & MORING LLP, INTELLECTUAL PROPERTY GROUP, P.O. BOX 14300, WASHINGTON, DC, 20044-4300, US

(73) Assignee: Eurocopter Deutschland GmbH

(21) Appl. No.: 10/165,309

(22) Filed: Jun. 10, 2002

(30) Foreign Application Priority Data
Jun. 8, 2001 (DE) 101 28 020.3

(51) Int. Cl. G09B 9/08; G09B 19/16

(52) U.S. Cl. 434/30; 434/29

(57) ABSTRACT

The invention relates to a method for reproducing a recorded flight mission of an aircraft, in particular a helicopter, from an observer position by means of a flight simulation system. Flight data, which are recorded by a storage medium of a simulation computer and whose purpose is reproduction, can be retrieved by the flight simulation system. Furthermore, there is a device for carrying out the method. The object of the invention is to further improve, during reproduction of a recorded flight mission, the intuitive detectability of a deviation from a desired target flight path from an observer position by means of a flight simulation system for an aircraft. The problem is solved in that the simulation computer is equipped with a program for calculating at least one virtual observer position, where the program, with its effect on a program of a display computer, can control the display computer's help program for displaying a flight tunnel and the display computer's help program for displaying a three-dimensional image of the aircraft so that by means of the flight simulation system, a virtual observer position with a view of the aircraft during the flight mission can be displayed.

### BACKGROUND AND SUMMARY OF THE INVENTION

This application claims the priority of Application No. 101 28 020.3, filed Jun. 8, 2001, in Germany, the disclosure of which is expressly incorporated by reference herein.

Flight simulators are used for training pilots and evaluating new flight maneuvers. A flight simulator is a technical system. Such a system for flight simulation has at least one simulation computer with a large storage medium, several work stations for displaying and producing graphics, a sound system, and a display computer, which can be coupled to a simulation computer, for visualizing the environment with a three-channel display unit.

A known system for flight simulation has the ability of recording the completed flight mission on the storage medium of the simulation computer and of displaying this flight mission in connection with the display computer in a pictured and acoustical reproduction on the three-channel display unit. In this display, the pilot's view from the cockpit is reproduced. In evaluating the flight mission, the pilot's self-check is limited to this viewing mode. It is often difficult to perceive with this viewing mode where the pilot is at any instant with respect to the environment. Therefore, to facilitate the self-check, flight guidance symbols can also be overlaid, upon request, in order to make clear whether a desired flight path remains or not. This is done, for example, by overlaying the symbol of a flight tunnel. Such an overlaying must be done on the basis of the values of one's own experience during observation. Possible errors are not immediately intuitively detectable by means of this one-sided viewing mode.

An object of the invention is to further improve, during reproduction of a recorded flight mission, the intuitive detectability of a deviation from a desired target flight path from an observer position by means of a flight simulation system for aircraft.

The problem is solved by means of reproducing a recorded flight mission of an aircraft, in particular a helicopter, from an observer position by means of a flight simulation system. The flight data, which are recorded by a storage medium of a simulation computer and whose purpose is reproduction, can be retrieved by the flight simulation system. The simulation computer is equipped with a program for calculating at least one virtual observer position. The program, with its effect on a program of a display computer, can control the display computer's help program for displaying a flight tunnel, and the display computer's help program for displaying a three-dimensional image of the aircraft so that the flight simulation system, from a virtual observer position with a view of the aircraft during the flight mission, can be displayed during the reproduction procedure. The invention has the advantage of displaying in the reproduction function the course of the flight from the view of an external observer, the pilot. It is equivalent to producing a virtual observer position. In accordance with the specific flight mission, the optimal virtual observer position can be chosen during reproduction for evaluating the flight mission. A choice of view can be made among three virtual observer positions; during reproduction, one can also alternate between them. These three observer positions are described in the embodiments described below.

A further object of the invention is three-dimensional display of the aircraft that renders a realistic display of the motion of the aircraft possible.

A still further object of the invention is a device for carrying out the method consists of the simulation computer having a program, which comprises the help program for displaying a flight tunnel and the help program for displaying a three dimensional image of the aircraft and which calculates at least one virtual observer position.

Other objects, advantages and novel features of the present invention will become apparent from the following detailed description of the invention when considered in conjunction with the accompanying drawing.

### BRIEF DESCRIPTION OF THE DRAWINGS

FIG. 1 is a schematic drawing of a flight simulation system.

### DETAILED DESCRIPTION OF THE PREFERRED EMBODIMENT

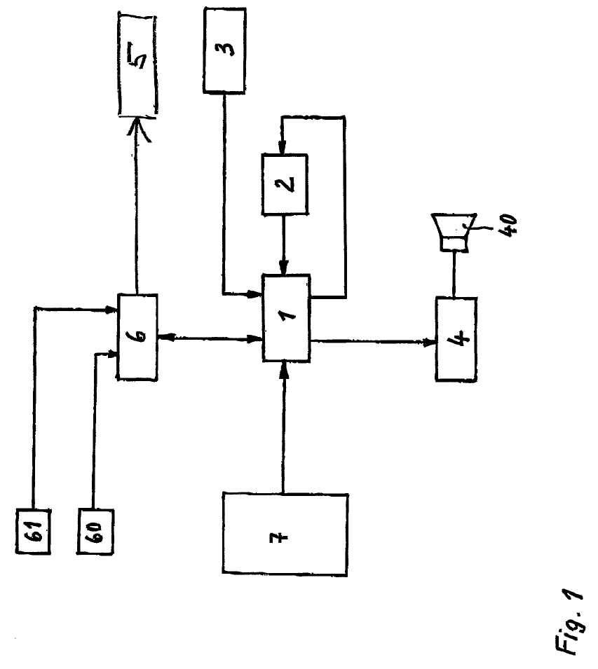

FIG. 1 is a schematic drawing of a flight simulation system, having several modules. A simulation computer 1 assumes a central position. The simulation computer 1 is equipped with an extensive, electronic storage medium 2. This storage medium 2 serves to record the simulated flight data of a flight mission. A flight mission comprises, for example, the takeoff, travel flight, and landing of a helicopter. However, the flight mission may also have other, limited, partial missions, such as flying along a straight narrow forest clearing or the like. The complete flight mission or parts of this flight mission may be stored completely on the storage medium 2. Therefore, the flight simulation system is frequently used to train especially for challenging flight missions. For this purpose, the simulated flight mission is recorded by the storage medium 2 and is available for reproduction at the desired time for the operating personnel. When such a reproduction of the recorded flight mission is retrieved from the simulation computer 1, the flight data, stored in the storage medium 2, are retrieved. In this respect, the simulation computer 1 works together with individual workstations 3 for display and graphics and a sound system 4 with loudspeakers 40. The workstation 3 for display and graphics is an electronic device for converting flight data into image data and for displaying symbol graphics. The sound system 4 is also an electronic device that produces the noises of a helicopter and the environment by means of loudspeakers 40.

To display an image on the three-channel display unit (not shown), the simulation computer 1 works together with a display computer 6 for visualizing the environment.

The invention proceeds from the hypothesis that a virtual observer position is calculated in the simulation computer 1 and is displayed on the three-channel display unit, which gives the observer a view of the helicopter, by way of a display computer 6. This is a different mode of viewing than the prior art viewing mode. The prior art system showed only the viewing mode from the aircraft.

To calculate a virtual observer position with a view of the helicopter, the simulation computer 1 has a corresponding program 7. With the request to reproduce, this program 7 is retrieved to calculate a virtual observer position and is actuated for the purpose of calculating. It uses for the purpose of calculation the flight data, stored on the storage medium 2. For this purpose, a help program 60 may be loaded into the display program of the display computer 6 for the purpose of displaying graphically a three-dimensional image of a helicopter. Moreover, by means of the display program of the display computer 6, a help program 61 can be retrieved for displaying a flight tunnel and other flight guidance symbols. These two help programs 60, 61 are integrated into the program of the display computer 6 for calculating the external view and are retrieved and terminated by the program 7.

The simulation computer 1 is also connected to at least one workstation 3 for display and graphics.

The display computer 6 serves to visualize the environment. Its connection to the simulation computer 1 enables the pictured and acoustical display of the environment by means of the three-channel display unit, whereby it can also resort to the stored flight data from the storage medium 2. The three-channel display unit is also controlled by the display computer 6.

The flight simulation system can use a cockpit construction, specific to a desired type of helicopter. This reproduced segment of the cell of the cockpit has at least the operating levers for the pedal control, the cyclic control, and the collective control, and an instrument panel with large surface LCD displays for displaying the flight instruments. The necessary screen graphics are produced by at least one workstation 3 for display and graphics and visualized on the LCD displays. The simulation computer 1 may correspond to a UNIX and VxWorks-based VME system. The three-channel display unit may include, for example, three CRT projectors with the three-channel display computer 6.

The program 7 for calculating a virtual observer position with a view of the helicopter may realize, for example, three modes of viewing the helicopter:

I. A first viewing mode may have the observer's position and view direction located in a fixed position with respect to a specific point in the earth coordinate system. That can be, for example, the view direction north of a fixed landmark. Thus, the observer is in a fixed location in relation to a defined approach and departure tunnel of the helicopter. If the helicopter moves toward the observer and the helicopter flies over the observer, the helicopter disappears from the observer's view direction. This position and view direction are especially advantageous when viewing a takeoff or approach to land flight.

II. A second viewing mode may include the observer's position moving along at a defined distance from the helicopter. However, the view direction is preset permanently in the earth coordinate system. For example, the view direction can always be from 180 degrees (south).

III. A third viewing mode may include of the observer's position also moving at a defined distance from the helicopter, but the observer's view direction is always moved in the direction of the heading of the helicopter. Thus, one has always a view of the side of the helicopter.

The observer's position and view direction may be changed according to the three preset viewing modes (I., II., III.). During reproduction, one may switch between the display of the three viewing modes in the flight simulation system.

This feature has the advantage that in accordance with the specific flight mission the most advantageous viewing mode for evaluating the flight mission can be chosen directly.

Thus, the invention provides the possibility of displaying in the reproduction function the course of the flight from the view of an external observer, the pilot.

The three-dimensional display of the helicopter makes it possible to display realistically in space the movement of the helicopter. Thus, when evaluating the flight mission within the framework of the reproduction function, direct conclusions about the pilot's behavior in handling the helicopter can be drawn. This possibility yields a distinct learning effect and provides evidence for necessary changes in a pilot's handling behavior.

For the flight mission of the takeoff or landing, a desired flight path is pre-calculated by the flight simulation system. In consideration of the constant, reliable vertical and horizontal deviations, an approach or departure tunnel is calculated, in which the takeoff or the landing is supposed to take place. This calculation is done by the program 7 for calculating a virtual observer position with a view of the helicopter, whereby a help program 61 for displaying a flight tunnel is included in the calculation of the program by the display computer 6. This help program 61 is controlled by the program 7.

The program 7 for calculating a virtual observer position with a view of the aircraft (for example, a helicopter) can also control, moreover, a help program 60 for displaying a three-dimensional image of an aircraft (for example, a helicopter) by way of the program of the display computer 6. Thus, the image display of a desired type of aircraft is met.

The program 7 for calculating a virtual observer position can be already installed in the simulation computer 1 of the system and can be downloaded by a computer, which can be coupled to the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for reproducing a recorded flight mission of an aircraft from an observer position comprising:
recording flight data on a recording medium of a simulation computer;
retrieving said flight data from said recording medium of said simulation computer;
calculating one or more virtual observer positions with a program on said simulation computer;
displaying a flight tunnel on a display device; and
displaying a three-dimensional image of said aircraft in said at least one virtual observer position on said display device.

2. The method of claim 1, wherein an observer view direction and at least one of said one or more virtual observer positions are in a fixed position with respect to a specific point in an earth coordinate system.

3. The method of claim 1, wherein said at least one of said one or more virtual observer positions moves along at a defined distance from said aircraft.

4. The method of claim 2, wherein said observer view direction is moved in a direction of said aircraft.

5. The method of claim 1, wherein said at least one of said one or more virtual observer positions can alternate among a plurality of locations.

6. A method for reproducing a recorded flight mission of an aircraft from an observer position comprising the steps of:
recording flight data on a recording medium of a simulation computer;
retrieving said flight data from said recording medium of said simulation computer;
calculating one or more virtual observer positions with a program on said simulation computer;
displaying a flight tunnel on a display device; and
displaying a three-dimensional image of said aircraft in said at least one virtual observer position on said display device.

7. A device for reproducing a recorded flight mission of an aircraft from an observer position comprising:
a simulation computer;
a display computer;
a display unit; and
a work station.

8. The device of claim 7, wherein said display computer controls said display unit.

9. The device of claim 7, wherein said simulation computer interacts with said display computer.

10. The device of claim 7, wherein said simulation computer further comprises a storage medium and one or more programs.

11. The device of claim 10, wherein at least one of said one or more programs calculates one or more virtual observer positions.

12. The device of claim 11, wherein said display unit displays a three-dimensional image of said aircraft from at least one of said one or more virtual observer positions.

13. A device for reproducing a recorded flight mission of an aircraft comprising:
a simulation computer having a storage medium for storing and retrieving flight data and a program for calculating one or more virtual observer positions; and
a display computer for displaying a flight tunnel and a three-dimensional image of said aircraft from at least one of said one or more virtual observer positions.

14. The device of claim 13, wherein said display computer further comprises a help program.

15. A device for reproducing a recorded flight mission of an aircraft comprising:
means for storing and retrieving flight data;
means for calculating one or more virtual observer positions;
means for displaying a flight tunnel; and
means for displaying a three-dimensional image of said aircraft from at least one of said one or more virtual observer positions.
